(19) United States
(12) Patent Application Publication
(10) Pub. No.: US 2015/0281227 A1
(43) Pub. Date: Oct. 1, 2015

(54) SYSTEM AND METHOD FOR TWO FACTOR USER AUTHENTICATION USING A SMARTPHONE AND NFC TOKEN AND FOR THE AUTOMATIC GENERATION AS WELL AS STORING AND INPUTTING OF LOGINS FOR WEBSITES AND WEB APPLICATIONS

(71) Applicant: Symple ID Inc., Waterloo (CA)

(72) Inventors: Richard Gordon Fox Ivey, Waterloo (CA); Kristopher Andrew Braun, Waterloo (CA); James Blashill, Kitchener (CA)

(21) Appl. No.: 14/600,391

(22) Filed: Jan. 20, 2015

Related U.S. Application Data
(60) Provisional application No. 61/972,702, filed on Mar. 31, 2014.

(30) Foreign Application Priority Data
Jan. 19, 2015 (CA) 2878269

(51) Int. Cl. H04L 29/06; H04L 9/32; G06F 21/46; H04W 12/06; G06F 21/35

(52) U.S. Cl. CPC H04L 63/0853; H04W 12/06; H04L 63/083; G06F 21/35; G06F 21/46; H04L 9/3226

(57) ABSTRACT

The present matter relates generally to the matter of authenticating users for login to websites and web applications to use a computer service. More specifically the matter of using a communication device such as a smartphone and NFC-based token as a two factor authentication solution for authenticating to use computer services such as logging into websites and web applications. The matter also pertains to the automated generation as well as storing of online user credentials to the user's communication device, encrypting them using a unique identifying code stored on an NFC-based token, or other wireless token that is proximate, and the automated process of supplying those credentials to a paired computer for the purposes of automatic login.

### CROSS-REFERENCE

This application claims the benefit of U.S. provisional application No. 61/972,702 filed Mar. 31, 2014, the contents of which are incorporated in their entirety.

### FIELD

The present matter relates generally to the matter of authenticating users for login to websites and web applications. More specifically the matter of using a smartphone and short-range wireless (e.g. NFC-based) encryption token as a two factor authentication solution for logging into websites and web applications. The matter also pertains to the automated generation as well as storing of online user credentials to the user's smartphone, encrypting them using a unique identifying code stored on a short-range wireless encryption token, and the automated process of supplying those credentials to a paired computer for the purposes of automatic login.

### BACKGROUND

The problem of passwords is well-known. The average person has more than 20 online web accounts or web applications which they utilize and each requires a username and password to authenticate the user. However, many users fail to create and use strong and unique passwords for their online accounts and applications and instead reuse passwords across accounts. This practice exposes them to the risk of loss of personal information as a result of credentials from one hacked account being used to hack another.

In attempts to block unauthorized access to accounts due to poor password practices (simple passwords and/or reusing them) many websites are now adopting two-factor authentication systems which require the user to supply a password as well as some other form of information (e.g. a number) to uniquely identify them. However such two-factor systems are not universal and vary from site to site, making them inconvenient for users to adopt.

Those who do attempt to create strong and unique passwords for their accounts often fail to remember them and waste time guessing or resetting accounts.

In aggregate these issues are often referred to as “the Password Problem”. There are a number of companies trying to solve the “password problem”. Notable examples include:

Internet Browser (Google Chrome/Firefox/Microsoft Internet Explorer) password management. These solutions store credentials in the browser of the user's computer. Browser password management solutions are recognized as insecure due to the fact that credentials can be easily obtained by using hacking tools which are readily available online.

1Password by AgileBits. Relies on users picking a single master password, that they haven't used elsewhere, that is strong enough to prevent others from guessing it and then stores all credentials in the cloud and/or on the computer which the user is using (work computer, home, internet café, etc.).

LastPass Relies on users picking a single master password, that they haven't used elsewhere, that is strong enough to prevent others from guessing it and then stores all credentials in the cloud and/or on the computer which the user is using (work computer, home, internet café, etc.).

(WO2013089777) LOGIN VIA NEAR FIELD COMMUNICATION WITH AUTOMATICALLY GENERATED LOGIN INFORMATION (http://patentscope.wipo.int/search/en/detail.jsf?docId=WO2013089777&recNum=101&docAn=US2011065493&queryString=adapter&maxRec=616849). This patent application describes a system and method for automatically generating login information, storing it and performing a login for the user on a computer by transmitting data between the computer and an authorized smartphone over an NFC connection. The process involves detecting the user's intent to login on a computer, communicating this over NFC to an authorized smartphone, generating and saving user credentials on the smartphone (or retrieving previously stored ones) and sending the new/stored credentials back to the computer and performing an automated login. The concept of generating a one-time password to include with other credentials is also mentioned. This patent application relies on users having an NFC-enabled computer in addition to an NFC-enabled smartphone.

TWO-FACTOR USER AUTHENTICATION USING NEAR FIELD COMMUNICATION U.S. Pat. No. 8,478,195 B1 (https://www.google.com/patents/US8478195?dq=two+factor+password+manager+NFC&hl=en&sa=X&ei=qLYPU7D9B8TWvQGDoYGwCQ&ved=OCDMQ6AEwAA). This patent application involves authenticating a user to utilize a mobile device by way of a combination of a user-entered password and a identifier stored on an NFC token. The authentication process involves the user entering a password on the device, then reading an NFC token; if both the password and NFC identifier are correct the mobile device is then unlocked.

NFC ENABLED DEVICES TO STORE AND RETRIEVE PORTABLE APPLICATION-SPECIFIC PERSONAL INFORMATION FOR USE WITH COMPUTATIONAL PLATFORMS EP 2541978 A1 (https://www.google.com/patents/EP2541978A1?cl=en&dq=nfc+to+login+smartphone+browser&hl=en&sa=X&ei=azP1UuTJC8KCyAHi6IGQDw&ved=0OCDoQ6AEwAQ) and NFC-ENABLED DEVICES TO STORE AND RETRIEVE PORTABLE APPLICATION-SPECIFIC PERSONAL INFORMATION FOR USE WITH COMPUTATIONAL PLATFORMS US 20120329388 A1 (https://www.google.com/patents/US20120329388?dq=password++nfc&hl=en&sa=X&ei=W_EPU6XeIISMaQHji4DoBg&ved=0CEAQ6AEwAjaU). These patent applications describe a process of storing and communicating “portable application-specific personal information (credentials, cookies and sets of cookies) to a web-based application” (including social media, banking and online shopping) over NFC in order to perform commands such as reset the computational platform, restart the computational platform, perform a virus scan, and perform a malware scan.

NEAR FIELD COMMUNICATION ELECTRONIC DEVICE, LOGIN SYSTEM USING THE SAME AND METHOD THEREOF US 20120185769 A1 (https://www.google.coml/patents/US20120185769?dq=using+nfc+to+login&hl=en&sa=X&ei=j-wPU9-SCMe6aaH59oHqBg&ved=0CDMQ6AEwAA). This patent application pertains to the development of NFC-based hardware which is “a reading module receiving identification information transmitted from a readable component when the readable component approaches; an embedded controller connected to the reading module and storing the identification information; and a matching module connected to the embedded controller and performing a matching authentication according to the identification information”.

FILE ENCRYPTION, DECRYPTION AND ACCESS VIA NEAR FIELD COMMUNICATION WO 2013095356 A1 (https://www.google.com/patents/WO2013095356A1?cl=en&dq=password+encryption+nfc&hl=en&sa=X&ei=t-wPU97cO4KRrqHivlCQaB&ved=0CDMQ6AEwAA). This patent application pertains to the encryption of documents on a device or by a device. NFC is used to perform various tasks such as transmitting a file name to a wireless device and transmitting an encryption key.

### SUMMARY

The present matter relates generally to the matter of authenticating users for login to websites and web applications. More specifically the matter of using a wireless communication device, such as a smartphone, and a short-range wireless (e.g. NFC-based) encryption token as a two factor authentication solution for authenticating to use computer services such as logging into websites and web applications. The matter also pertains to the automated generation as well as storing of online user credentials to the user's communication device, encrypting them using a unique identifying code stored on a short-range wireless (e.g. NFC-based) encryption token, and the automated process of supplying those credentials to a paired computer for the purposes of automatic login.

The systems and methods described below seek to solve the “password problem” by allowing users to sign into websites and web applications using a two-factor authentication solution that involves simple operation such as, in one embodiment, only a simple tap of their smartphone to an NFC-based token to login.

There is described a smartphone or other wireless communication device application, a short-range wireless (e.g. NFC-based) encryption token (e.g. an NFC token) which stores a code that is unique to the user, a browser extension, and a secure server. Two-factor authentication is provided in that it enables a user's wireless communication device (factor 1) and a unique encryption token (factor 2) to interact before supplying online credentials for login.

When browsing the Internet on an enabled computer (by way of a paired browser extension) the solution automatically detects login forms. When entering user names and passwords in a paired computer, the solution automatically transmits credentials through a secure server to a paired mobile device (e.g., smartphone, tablet, etc.) application which encrypts and stores them. User's credentials are encrypted using the unique code stored on their NFC token as an encryption key and stored locally to the user's personal smartphone or other mobile device as opposed to “in the cloud” or on the specific computer which they are using.

When revisiting a site for which a login has been stored, the solution detects the login form, checks to see if a login has been stored for the URL and, if so, prompts the user to, in one embodiment, tap their smartphone to their NFC token in order to authenticate them. Once authenticated (NFC code matches stored encryption code), the solution decrypts the appropriate login credentials stored on the smartphone and sends them through a secure server to the browser extension for login.

Lastly the solution can also automatically generate new passwords which are strong and unique and automatically update user accounts on configured computers using the newly generated passwords. Thus effectively removing passwords from the user experience entirely.

There is provided a first method for authenticating a use of a computer service comprising: storing user credentials at a communication device for authenticating the use of the computer service, wherein the user credentials are encrypted before storing; receiving a request at the communication device for the user credentials to authenticate the use of the computer service; communicating using near field communication (NFC) techniques with an NFC device to obtain a key to decrypt the user credentials; decrypting the user credentials using the key, only temporarily storing the key to perform the decrypting; and communicating the user credentials in response to the request.

The user credentials may be stored encrypted in a long term storage device of the communication device and the key is stored only in a short term storage device of the communication device.

The communication device may be a NFC-enabled smartphone, tablet or other wireless communication device, for example, which a user may carry with them. The communication device may be configured to communicate with an encryption token in a short range wireless manner where the token and communication device are proximate to one another such as using NFC, Bluetooth™ or other technologies.

There is provided a first method for authenticating a first communication device to use a computer service. The method comprises storing user credentials on a second communication device for authenticating the use of the computer service, wherein the user credentials are encrypted before storing; receiving a request at the second communication device for the user credentials to authenticate the use of the computer service; communicating using one of a) near field communication (NFC) techniques with an NFC device, and b) another short range wireless method with a wireless devices proximate to the communication device, to obtain a key to decrypt the user credentials; decrypting the user credentials using the key, only temporarily storing the key to perform the decrypting; and communicating the user credentials in response to the request.

The user credentials may be stored encrypted in a long term storage device of the second communication device and the key is stored only in a short term storage device of the second communication device.

The second communication device may be a smartphone, tablet, PC or other computing device configured to communicate using at least one of a) NFC techniques and b) another short range wireless method to obtain the key.

The method may comprise storing to the second communication device a plurality of user credentials for authenticating to respective different computer services, each of the plurality of user credentials stored in association with information to identify the respective different computer services and wherein the request identifies which computer service of the respective different computer services is to be authenticated.

The method of claim 1 wherein communicating the user credentials provides the user credentials for communication to a first communication device to authenticate the first communication device to use the computer service.

The method may comprise, before said step of storing user credentials: receiving user credentials to store to the communication device; communicating using one of a) NFC techniques with an NFC device and b) another short range wireless method with a wireless device proximate to the communication device to obtain a key to encrypt the user credentials; and encrypting the user credentials using the key to encrypt, only temporarily storing the key to encrypt when performing the encrypting. User credentials may be received in association with an identification of the computer service and wherein the identification of the computer service is stored in the association with the user credentials as encrypted to facilitate subsequent retrieval.

There is provided a communication device comprising a processor, a plurality of storage devices including a long term storage device and a short term storage device and a plurality of communication subsystems, wherein at least some of the plurality of storage devices stores instructions and data to configure the processor to perform a method for authenticating a use of a computer service, comprising: storing user credentials on the communication device for authenticating the use of the computer service, wherein the user credentials are encrypted before storing; receiving a request at the communication device for the user credentials to authenticate the use of the computer service; communicating using one of a) near field communication (NFC) techniques with an NFC device, and b) another short range wireless method with a wireless devices proximate to the communication device, to obtain a key to decrypt the user credentials; decrypting the user credentials using the key, only temporarily storing the key to perform the decrypting; and communicating the user credentials in response to the request.

There is provided a computer storage device storing instructions and data in a non-transient manner to configure a processor of a communication device to perform a method for authenticating a use of a computer service comprising: storing user credentials on the communication device for authenticating the use of the computer service, wherein the user credentials are encrypted before storing; receiving a request at the communication device for the user credentials to authenticate the use of the computer service; communicating using one of a) near field communication (NFC) techniques with an NFC device, and b) another short range wireless method with a wireless devices proximate to the communication device, to obtain a key to decrypt the user credentials; decrypting the user credentials using the key, only temporarily storing the key to perform the decrypting; and communicating the user credentials in response to the request.

There is provided a second method, namely, a method of authenticating a first communication device to use a computer service, comprising: associating the first communication device with a second communication device, the second communication device configured to provide user credentials for authenticating the first communication device to use the computer service; receiving a request for user credentials to obtain the use of the computer service; determining an identification of the computer service; communicating a request for the user credentials including the identification to obtain the user credentials from the second communication device, the second communication device configured to store the user credentials in an encrypted manner and decrypt the user credentials using a key obtained using one of a) near field communication (NFC) techniques from a NFC-enabled device and b) another short range wireless method with a wireless device proximate to the second communication device; receiving the user credentials in response to the request; and providing the user credentials to receive the computer service.

The step of communicating a request for the user credentials may be facilitated by a secure server in communication between the first communication device and the second communication device. The step of associating may be facilitated by a secure server in communication between the first communication device and the second communication device.

The second method may comprise comparing the identification of the computer service with a previously stored identification to determine whether the user credentials are available from the second communication device. Further, the second method may comprise, in response to a determining that the user credentials are not available: one or more of receiving at least some of the user credentials via input to the first communication device and generating at least some of the user credentials automatically; communicating the user credentials and the identification of the computer service for storing by the second communication device for subsequent authentication requests.

In the second method, receiving a request for user credentials may comprise receiving communications from the computer service comprising login requests and automatically detecting the login requests in the communications.

The second method may comprise automatically updating at least some of the user credentials including: generating a strong new password to replace an existing password of the user credentials; and communicating the user credentials as updated for storage by the second communication device; and communicating the user credentials as updated for storage by the computer service.

There is provided a communication device comprising a processor, a plurality of storage devices including a long term storage device and a short term storage device and a plurality of communication subsystems, wherein at least some of the plurality of storage devices stores instructions and data to configure the processor to perform the second method.

There is provided a computer storage device storing instructions and data in a non-transient manner to configure a processor of a first communication device to perform the second method.

There is provided a third method of authenticating a first communication device for a use of a computer service comprising: receiving a request from the first communication device for user credentials to obtain the use of the computer service; communicating a request to a second communication device for the user credentials, the second communication device configured to provide user credentials for authenticating the first communication device to use the computer service and further configured to store the user credentials in an encrypted manner and decrypt the user credentials using a key obtained using one of a) near field communication (NFC) techniques from a NFC-enabled device and b) another wireless method with a wireless device proximate to the second communication device; receiving the user credentials from the second communication device in response to the request; and providing the user credentials to the first communication device to receive the computer service.

The third method may comprise associating the first communication device with the second communication device.

The third method may comprise, before said step of receiving a request from the first communication device, receiving from the first communication device the user credentials for authenticating to use the computer service and communicating the user credentials to the second communication device for storing in the encrypted manner.

In the third method, requests for user credentials may be associated with an identification of the computer service so that the second communication device may determine the correct user credentials to communicate to the server communication device.

There is provided a server communication device comprising a processor, a plurality of storage devices including a long term storage device and a short term storage device and at least one communication subsystem, wherein at least some of the plurality of storage devices stores instructions and data to configure the processor to perform the third method.

There is provided a computer storage device storing instructions and data in a non-transient manner to configure a processor of a server communication device to perform the third method.

There is provided a fourth method of authenticating a use of a computer service using two-factor authentication. The fourth method comprises communicating, from a smartphone, user credentials to authenticate to use the computer service, the smartphone storing the user credentials in an encrypted manner and decrypting the user credentials for communicating using a key obtained by a) near field communication (NFC) techniques from a NFC-enabled device storing the key and b) another wireless method with a wireless device proximate to the smartphone storing the key.

These and other methods, communication devices and computer program products, among other aspects, will be apparent.

### BRIEF DESCRIPTION OF THE DRAWINGS

The present matter may be further understood by reference to the following description in conjunction with the appended drawings in which:

FIG. 1 is a block diagram of a system for two factor user authentication, in accordance with one embodiment, which uses a smartphone and an NFC token and provides for the automatic generation as well as storing and inputting of logins for websites and web applications.

FIG. 2 is a flow chart describing the process of storing a new set of credentials in the smartphone application accordingly to an embodiment of the present matter.

FIG. 3. Is a flow chart describing the process of detecting a login in the browser extension, validating the website, and authenticating the user in the smartphone application, decrypting and passing credentials through the secure server to the remote computer browser, and finally automatically logging the user into the site/application in accordance with one embodiment.

FIG. 4. Is a flow chart describing the process of detecting a login on a website using the browser extension, validating the website and authenticating the user in the smartphone application, decrypting and passing credentials through the secure server to the remote computer browser, logging the user in automatically, generating and saving a new password in the online user account and sending the password back to the smartphone for saving in accordance with one embodiment.

In the following description like numerals refer to like structures and process in the diagrams.

### DETAILED DESCRIPTION

Overview: Described herein is a two-factor authentication solution which combines a user's website password (stored on a smartphone) as one factor and a passkey stored on an encryption token as a second factor. The solution is applied to the act of securely and easily logging users into websites and web applications on their desktop/laptop/tablet using their smartphone or other wireless communication device, a unique wireless encryption token such as a near-field communication (NFC) token (wristband, key-fob, sticker, wallet card, jewelry, an NFC-enabled smart watch, etc.) and an extension to their web browser.

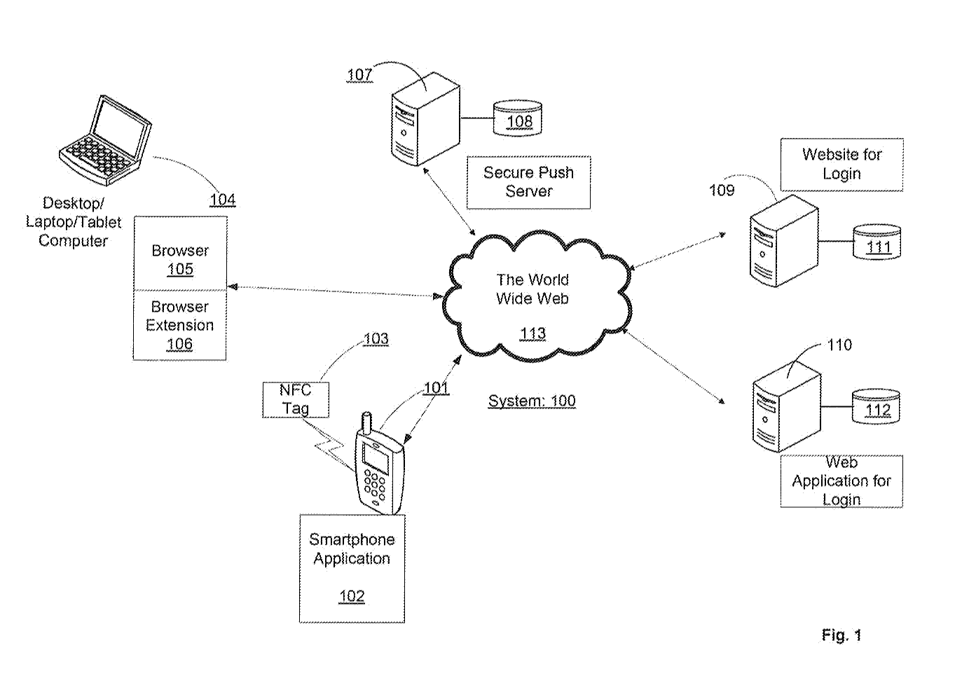

Example Framework: FIG. 1 outlines the principle components of a system 100 including a Near-field Communication-enabled (NFC) smartphone 101 and smartphone application 102, an NFC token 103 encoded with a code that is unique to the user, a desktop/laptop/tablet computer 104 with a browser 105, a browser extension 106 and a secure server 107 in accordance with one embodiment. The desktop/laptop/tablet computer 104 may be referenced as a first communication device requiring authentication to use a computer service and smartphone 101 may be referenced as a second communication device configured to store and provide user credentials to authenticate the first communication device to use the computer service.

There is shown a smartphone 101 having a smartphone application 102 for receiving website data, usernames, passwords and encrypting and storing them for subsequent retrieval. Smartphone 101 is NFC capable and may be in selective communication with NFC token 103 as further described. System 100 further comprises a user computer 104 such as a tablet, laptop or desktop having a browser 105 and browser extension 106 for communicating via the world wide web 113 with other computers, often in the form of servers such as secure server 107 and, optionally, a data store 108, website 109 and web application 110. Each of website 109 and web application 110 may have a respective data store 111 and 112. It will be apparent that the system 100 is simplified and that various networks and network devices are not illustrated. Website 109 and web application 110 or other web servers/applications (not shown) may provide one or more computer services for which the first communication device requires authentication (e.g. such as by providing a user name and password or other user credentials) to gain access to a respective computer service.

Smartphone 101 technology is well-known and includes a wide range of mobile devices which possess the ability to connect to WiFi and cellular data networks, store and retrieve data and run applications. NFC-enabled smartphones are those which have the necessary hardware and software to make connections with other devices through near-field communication. Near-field communication dates back to the early 2000s and is a standards-based technology that builds upon Radio Frequency Identification (RFID) technology. NFC enables wireless devices to establish radio communication with each other through the act of bringing them into close proximity with one-another.

In accordance with the teachings herein, the smartphone application 102 provides for a range of features including the ability to pair it to a desktop/laptop/tablet 104 by way of a unique passcode, which can be automatically generated on demand by the user, and which is entered in the smartphone application as well as the browser extension 106. Paired smartphones 101 and desktop/laptop/tablets 104 can communicate information (including usernames, passwords and URLs) between one-another through the secure server 107. The smartphone application 102 provides for the automated encryption and storage of usernames, passwords and URLs passed from the browser extension 106 through the secure server 107 to the local storage on the smartphone 101. Ongoing automated encryption of stored credentials is made possible through the reading and storage to temporary memory of a unique code (used as an encryption key) stored on an NFC token 103. Additionally the smartphone application provides for the confirmation of the desire to login on a paired desktop/laptop/tablet 104, and authentication of the user, by way of the user tapping their smartphone 101 to their NFC token 103, retrieving a stored code, and validation of the tag-stored code against the code used previously to encrypt stored credentials. The smartphone application 102 provides for the validation of the authenticity of a website prior to supplying stored credentials by comparing the candidate URL against the library of stored URLs. This helps to prevent against “phishing” attacks wherein a user mistakes a forged website for the genuine website. Upon detection of a website/web application login, the browser extension 106 sends the URL of the detected login through the secure server to the smartphone application 102 which in turn validates the URL against stored URLs. The smartphone application also provides for the decryption and copying and pasting of passwords (following authentication with the NFC ID (e.g. a key stored to the NFC token 103) into other applications installed on the smartphone 101 to permit sharing of stored passwords with smartphone applications.

NFC tokens are unpowered devices capable of sharing data wirelessly when powered by an NFC-enabled device that is brought within proximity. The NFC token 103 disclosed herein is used to store a unique identifier for the user (e.g., a 100 digit, randomly-generated code) which is utilized by the smartphone application 102 to encrypt stored user credentials as well as to authorize login requests from remote desktop/laptop/tablet computers 104 and subsequently decrypt credentials for use in automated logins.

Desktop/laptop/tablet devices 104 are well known, have one or more processors, memory, I/O devices and communication subsystems and are typically configured using software (instructions and data) stored in memory or otherwise accessible to the processors to control execution. Internet Browser technologies 105 as also well-known and are software applications which allow users to access websites and web applications hosted on the world wide web 113, or internal networks, through wireless (e.g., WiFi) and cabled data connections.

A browser extension is a software application which installs in the user's Internet Browser and provides “extended” functionality to the end-user. In system 100 according to the present embodiment, the browser extension 106 provides a range of capabilities including: an algorithm for the detection of web login and account sign-up forms, user notification by way of onscreen display of messages such as “tap to login”, and two-way communication with a secure server 107 for the purposes of sending and receiving user credentials and other browser data (e.g., URLs, and word form fields) to and from the smartphone application. Importantly, the browser extension 106 is capable of injecting received user credentials into web forms and initiating logins automatically. Lastly the browser extension 106 provides for the automatic generation of unique and strong passwords for websites and web applications, and the automated updating of user accounts to use new credentials. Automated updating of user accounts is initiated by the user tapping to sign-in. Upon successful sign-in, the browser extension 106 programmatically opens the application/site settings menu, then opens the password update form, generates a new password and inputs both the new password and old password (received from the smartphone application 102), into the password update form. Lastly the extension programmatically presses the “save” button for the password update form. Automated changing of user credentials can be performed every-time the user logs into an account, or on some temporal basis such as, but not limited to, every minute, hour, day, week or month.

The secure server 107 comprises a configuration which provides for user-specific secure channels which permit the flow of information between the smartphone application 102 and the paired desktop/laptop/tablet 104 by way of the browser extension 106. User credential data transmitted through the secure server are deliberately not stored to the secure server's data store 108 in order to protect user accounts and user privacy.

The use of wearable technology (devices) such as, but not limited to, smart-watches, fitness trackers, wearable heart-rate monitors, etc., as an alternative to the use of an NFC token as an authentication “factor” is contemplated. In this scenario, a unique code for the device (to serve as the alternate to an NFC token-stored code) would be generated based on one or more factors pertaining to the device. For example individually, or in combination; the device's serial number, IP address, MAC address, measured heart-rate/pulse of the wearer, etc. would be combined to generate a unique code used for authentication and encryption. Communication between the user's smartphone and wearable devices may be via short range wireless methods other than NFC.

Example Methods:

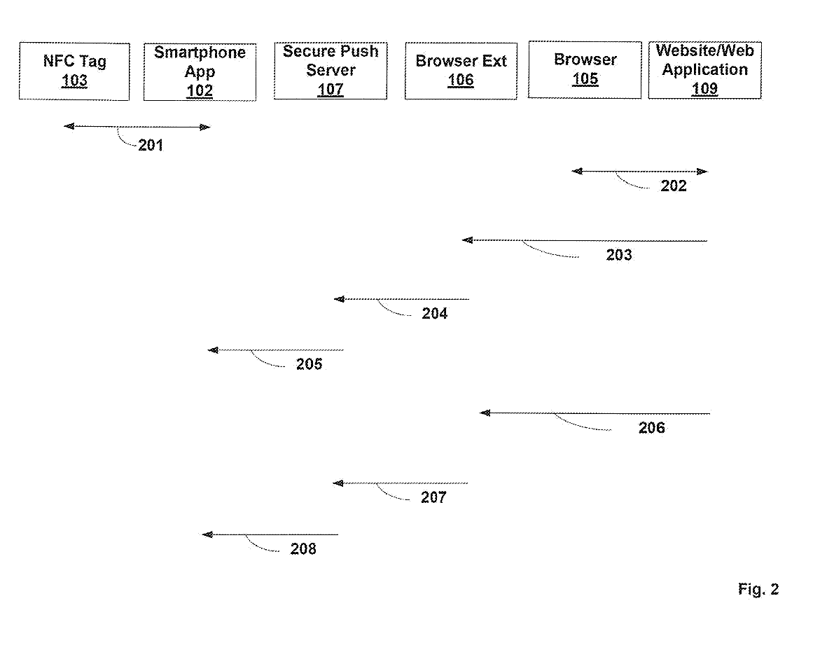

FIG. 2 Shows a set-up or configuration process 200, in accordance with one example, of a user storing credentials (username and password) to the smartphone application 102. The operations may be programmed in software into the respective components. The process begins at step 201 with the user opening the application and tapping their smartphone to their NFC token 103 when prompted by the smartphone application 102. This act stores the unique code written to the NFC token 103 in the smartphone application's 102 temporary memory in order to enable it to be used for automatic ongoing encryption of received passwords during the user's session. In this way user credentials are later only accessible following decryption using the unique key stored to the NFC token 103 which the user has initially stored. Upon disabling this feature or closing the smartphone application 102 the unique code is removed/destroyed from the temporary memory.

The next step 202 is for the user to visit a website or web application 109 using the configured browser 105.

In step 203 the browser extension 106 will then automatically detect the login fields in the website 109 by way of an algorithm which searches visited pages for entities such as, but not limited to, “username”, “password” and “login”. Upon detection of these elements, the browser extension 106 displays an onscreen message to notify the user.

In step 204 the browser extension 106 will send entered credentials, web form information (e.g., field names) and URL address to the secure server 107.

In step 205 the secure server 107 sends web form information (e.g., field names) and URL address to the smartphone application 102. The smartphone application 102 will check local memory to determine if a record exists for the received URL. If no such record exists it will wait to receive login information entered by the user in the browser 105.

In step 206 the user inputs their existing username and password into the login form and completes the login.

In step 207 the browser extension 106 will send entered credentials, along with web form information (e.g., field names) and URL address to the 107.

In step 208 the secure server sends web form information (e.g., field names) and URL address to the smartphone application 102 for encryption (using the previously stored code from step 201) and local storage.

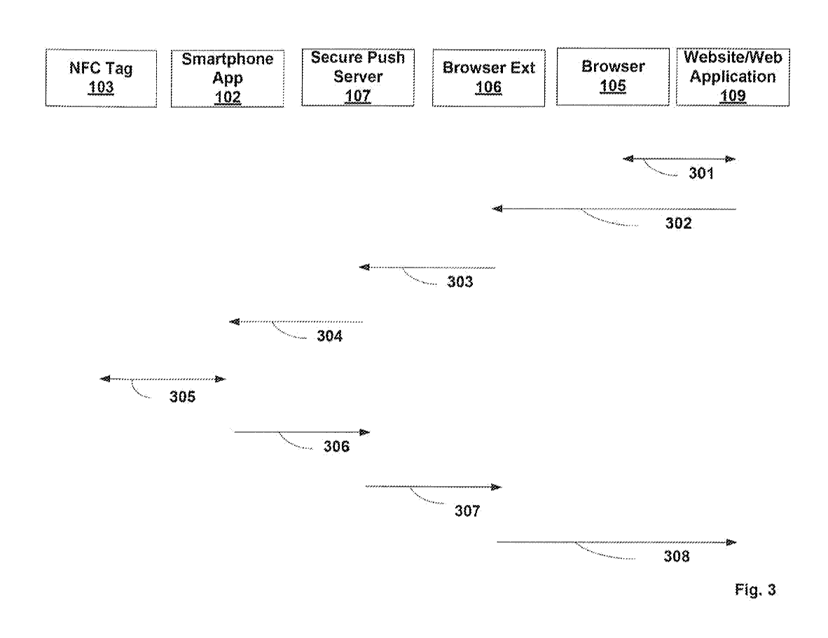

FIG. 3 shows the process of automatically logging a user into a website or web application for which user credentials have previously been stored in the smartphone application 102. The operations may be programmed in software into the respective components.

The process begins at step 301 with the user visiting a website or web application 109 using the configured browser 105.

In step 302 the browser extension 106 will then automatically detect the login fields in the website 109 by way of an algorithm which searches for entities such as, but not limited to, “username”, “password” and “login”. Upon detection of these elements, the browser extension 106 displays an onscreen message to notify the user as such.

In step 303 the browser extension 106 will send web form information (e.g., field names) and URL address to the secure server 107.

In step 304 the secure server 107 sends web form information (e.g., field names) and URL address to the smartphone application 102. The smartphone application 102 will check local memory to determine if a record exists for the received URL.

Upon finding a match in step 304, in step 305 the smartphone application 102 will prompt the user to bring the appropriate encryption token 103 into proximity in order to authenticate the user and decrypt the stored password.

If the appropriate encryption/decryption code is found on the encryption token 103, the stored password will be decrypted and sent along with the stored username, web form field information and website URL to the secure server 107 in step 306.

In step 307 the secure server 107 will transmit the password, username, web form field information and website URL to the browser extension 106.

In step 308 the browser extension will autofill the appropriate web form fields with the received user credentials and initiate an auto login (effectively press the login button for the user).

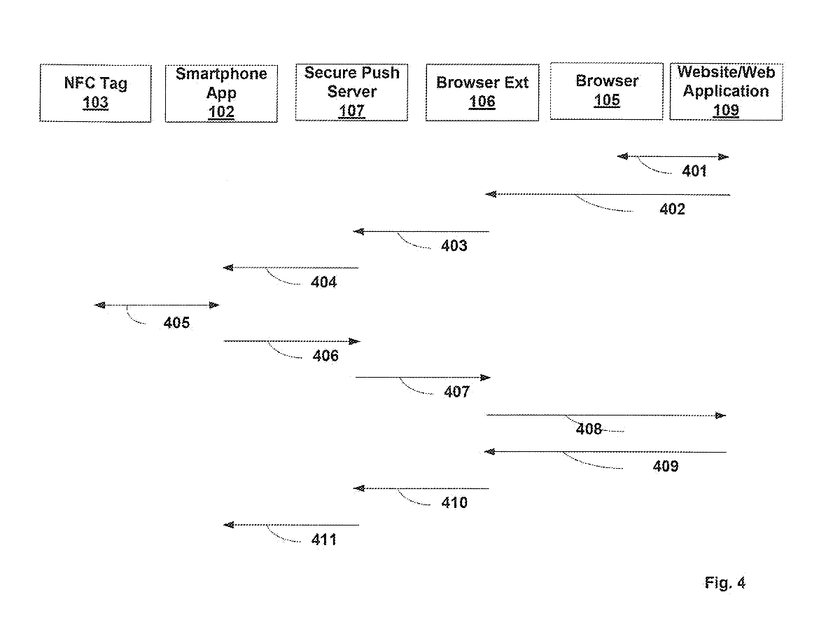

FIG. 4 shows a process to automatically log a user into a website or web application for which user credentials have previously been stored in the application 102 according to one example. Generating a new password, opening the settings page for the online account and updating the user password automatically by auto-filling forms using the old password and the new one. The operations may be programmed in software into the respective components.

The process begins at step 401 with the user visiting a website or web application 109 using the configured browser 105.

In step 402, browser extension 106 automatically detects the login fields in the website 109 by way of an algorithm which searches for entities such as “username”, “password” and “login”. Upon detection of these elements, the browser extension 106 displays an onscreen message to notify the user as such.

In step 403 the browser extension 106 will send web form information (e.g., field names) and URL address to the secure server 107.

In step 404 the secure server 107 sends web form information (e.g., field names) and URL address to the smartphone application 102. The smartphone application 102 will check local memory to determine if a record exists for the received URL.

Upon finding a match in step 404, in step 405 the smartphone application 102 will prompt the user to bring the appropriate encryption token 103 into proximity in order to authenticate the user and decrypt the stored password.

If the appropriate encryption/decryption code is found on the encryption token 103, the stored password will be decrypted and sent along with the stored username, web form field information and website URL to the secure server 107 in step 406.

In step 407 the secure server 107 will transmit the password, username, web form field information and website URL to the browser extension 106.

In step 408 the browser extension 106 will autofill the appropriate web form fields with the received user credentials and initiate an auto login (effectively press the login button).

In step 409 the browser extension 106 will programmatically push the onscreen button required to open the settings page and then the security page. Once the security page is open it will initiate the password changing process, generate a new password and autofill the password change form using the password just used to login for the old password and the newly generated password as the new one.

In step 410 the browser extension 106 will send the new password, along with web form information (e.g., field names) and URL address to the secure server 107.

In step 411 the secure server 107 sends the new password along with web form information (e.g., field names) and URL address to the smartphone application 102 for encryption (using the previously stored code from step 201) and local storage.

An alternative embodiment entails a paired smartphone-based browser software application and/or integration with native smartphone browser applications in lieu of pairing with a remote computer 104. In this scenario the functionality of the browser extension 106 would be resident in the smartphone browser. The system would provide for two-factor user authentication and automatic storing and inputting of logins for websites and web applications accessed through the smartphone's browser as opposed to a separate paired computer 104.

An alternative embodiment entails a scenario where the smartphone 101 and computer 104 are one-in-the-same device; such as an NFC-enabled laptop/desktop/tablet computer. In this scenario the functionality of the internet browser extension 106 as well as the smartphone application 102 would be resident in the same device.

An alternative embodiment entails the substitution of a user-entered password/code in lieu of a code stored on an NFC token 103 for the purposes of encryption and decryption on the smartphone. In this scenario the user would be prompted to enter their password/code in the smartphone application 102 in order to authenticate and to supply the encryption/decryption key (the entered password/code).

An alternative embodiment entails the substitution of a scanned barcode or image (e.g., a OR code) which contains a unique code in lieu of a code stored on an NFC token 103 for the purposes of encryption and decryption on the smartphone 101. In this scenario the user would be prompted scan a barcode or image with their smartphone 101 in order to authenticate and supply the encryption/decryption key.

An alternative embodiment entails the use of a wireless (e.g., NFC, WiFi, etc.) smart device capable of performing encryption and decryption onboard as opposed to within the smartphone application 102. In this scenario the part of the functionality provided for in the smartphone application 102 would be executed on the smart device (not shown). For example, smartphone application 102 may retrieve the encrypted user credentials from a long term smartphone storage device and communicate it to the paired smart device for decrypting and return, using a key stored to the smart device. Smartphone application 102 then returns the decrypted user credentials in response to the request for same (e.g. to a local browser or similar application or via the secure server 107 to browser extension 106). Smartphone application 102 only stores the decrypted user credentials in a temporary manner such as in a short term storage device and/or deletes same after communicating.

An alternative embodiment entails the installation of the solution in a Point of Sale or Automatic Banking Machine environment. In this scenario the solution provides for two-factor user authentication and automatic storing and inputting of logins for POS terminal and Automatic Banking Machine users. In this scenario the functionality of the browser extension 106 would be resident in the POS terminal and/or the ABM machine computer.

An alternative embodiment entails the installation of the solution in a secure dispensing environment. In this scenario the solution would provide for two-factor user authentication and automatic storing and inputting of logins for use in secure dispensing machines (e.g., for medicine, alcohol, other controlled goods, etc.). In this scenario the functionality of the browser extension 106 would be resident in the secure dispensing machine controller computer.

An alternative embodiment entails the installation of the solution in a machine-control environment. In this scenario the solution would provide for two-factor user authentication and automatic storing and inputting of logins for use in machine control environments (e.g., in a factory setting or to control access to and operation of specialized machinery, or even an automobile, etc. for personal or other use). In this scenario the functionality of the browser extension 106 would be resident in the machine control computer.

An alternative embodiment entails the use of an alternative method of short-range wireless communication (in lieu of NFC) between the smartphone 101 and a token, or device (wearable or otherwise), that is proximate. Short-range wireless methods could include, but are not necessarily limited to, Bluetooth™. In this scenario the user would initiate communication either from the wireless token in order to share the code with the smartphone application 102, or from the smartphone application 102 to the wireless token, thus authenticating the user and supplying the encryption/decryption key.

Another alternative embodiment entails the use of a longer-range wireless communication method (in lieu of NFC) between the smartphone 101 and a token, or device (wearable or otherwise) that is remote. Longer-range methods could include, but are not necessarily limited to, for example WiFi. In this scenario the user would initiate communication either from the wireless token in order to share the code with the smartphone application 102, or from the smartphone application 102 to the wireless token, thus authenticating the user and supplying the encryption/decryption key. It is recognized that this method could be less secure due to the potential remoteness of the user from the token, and the communication of data over a non-short range channel.

Though described as alternatives, a person of skill in the art will understand that a communication device may be configured (e.g. via a software application) to communicate with an encryption token or other form factor/device holding the key in more than one manner and similarly an encryption token or other form factor/device may be configured to communicate in more than open manner to provide the key. Selection of communication manner may be accomplished in a variety of ways including through user or other set-up.

It will be appreciated by those of ordinary skill in the art that the matter can be embodied in other specific forms without departing from the essential character describe herein.

1. A method for authenticating a first communication device to use a computer service comprising:
storing user credentials on a second communication device for authenticating the use of the computer service, wherein the user credentials are encrypted before storing;
receiving a request at the second communication device for the user credentials to authenticate the use of the computer service;
communicating using one of a) near field communication (NFC) techniques with an NFC device, and b) another short range wireless method with a wireless devices proximate to the second communication device, to obtain a key to decrypt the user credentials;
decrypting the user credentials using the key, only temporarily storing the key to perform the decrypting; and
communicating the user credentials from the second communication device in response to the request.

2. The method of claim 1 wherein the user credentials are stored encrypted in a long term storage device of the second communication device and the key is stored only in a short term storage device of the second communication device.

3. The method of claim 1 wherein the second communication device is a smartphone, tablet, PC or other computing device configured to communicate using at least one of a) NFC techniques and b) another short range wireless method to obtain the key.

4. The method of claim 1 comprising storing to the second communication device a plurality of user credentials for authenticating to respective different computer services, each of the plurality of user credentials stored in association with information to identify the respective different computer services and wherein the request identifies which computer service of the respective different computer services is to be authenticated.

5. The method of claim 1 wherein communicating the user credentials provides the user credentials for communication to the first communication device to authenticate the first communication device to use the computer service.

6. The method of claim 1 comprising, before said step of storing user credentials:
receiving user credentials to store to the second communication device;
communicating using one of a) NFC techniques with an NFC device and b) another short range wireless method with a wireless device proximate to the communication device to obtain a key to encrypt the user credentials; and
encrypting the user credentials using the key to encrypt, only temporarily storing the key to encrypt when performing the encrypting.

7. The method of claim 6 wherein user credentials are received in association with an identification of the computer service and wherein the identification of the computer service is stored in the association with the user credentials as encrypted to facilitate subsequent retrieval.

8. (canceled)

9. (canceled)

10. A method of authenticating a first communication device to use a computer service comprising:
associating the first communication device with a second communication device, the second communication device configured to provide user credentials for authenticating the first communication device to use the computer service;
receiving a request for user credentials to obtain the use of the computer service;
determining an identification of the computer service;
communicating a request for the user credentials including the identification to obtain the user credentials from the second communication device, the second communication device configured to store the user credentials in an encrypted manner and decrypt the user credentials using a key obtained using one of a) near field communication (NFC) techniques from a NFC-enabled device and b) another short range wireless method with a wireless device proximate to the second communication device;
receiving the user credentials in response to the request; and
providing the user credentials to receive the computer service.

11. The method of claim 10 wherein the step of communicating a request for the user credentials is facilitated by a secure server in communication between the first communication device and the second communication device.

12. The method of claim 10 wherein in the step of associating is facilitated by a secure server in communication between the first communication device and the second communication device.

13. The method of claim 10 comprising comparing the identification of the computer service with a previously stored identification to determine whether the user credentials are available from the second communication device.

14. The method of claim 13 comprising, in response to a determining that the user credentials are not available:
one or more of receiving at least some of the user credentials via input to the first communication device and generating at least some of the user credentials automatically;
communicating the user credentials and the identification of the computer service for storing by the second communication device for subsequent authentication requests.

15. The method of claim 10 wherein receiving a request for user credentials comprises receiving communications from the computer service comprising login requests and automatically detecting the login requests in the communications.

16. The method of claim 10 comprising automatically updating at least some of the user credentials including:
generating a strong new password to replace an existing password of the user credentials; and
communicating the user credentials as updated for storage by the second communication device; and
communicating the user credentials as updated for storage by the computer service.

17.-24. (canceled)

25. A method of authenticating a use of a computer service using two-factor authentication, the method comprising:
communicating, from a smartphone, user credentials to authenticate to use the computer service, the smartphone storing the user credentials in an encrypted manner and decrypting the user credentials for communicating using a key obtained by using one of a) near field communication (NFC) techniques from a NFC-enabled device storing the key and b) another wireless method with a wireless device proximate to the smartphone storing the key.
